(19) United States
(12) Patent Application Publication
(10) Pub. No.: US 2005/0101192 A1
(43) Pub. Date: May 12, 2005

(54) Trip resistant utility cord

(76) Inventor: Kenneth Foskey, Conyers, GA (US)

Correspondence Address: Kenneth Foskey, P.O BOX 2744, COVINGTON, GA, 30015, US

(21) Appl. No.: 10/702,017

(22) Filed: Nov. 6, 2003

(51) Int. Cl. H01R 25/00

(52) U.S. Cl. 439/650

(57) ABSTRACT

A utility extension cord or hose which has sloped sides and/or feathered edges so that it is trip resistant when laid on the floor in or near a pedestrian walk way. Means such as an adhesive surface, suction cups, Velcro, or barbed-like impingements may be used to secure the cord to a smooth or carpeted floor to further insure that the extension cord does not trip pedestrians. The cord may be color-coded, labeled, or embossed to designate information such as length or cord, wire size or number of wires and type of surface attachment. The extension cord may have male and female ridges and grooves to assist in rolling the cord into a secure neat roll for storage.

### BACKGROUND OF THE INVENTION

State of the art extension cords are round or oval without sloped or feathered edge, and without having means to secure then to a floor surface. Existing extension cords are generally tied into a loop without a definite means of neatly securing the cord to itself as it is rolled up for storage.

### SUMMARY OF THE INVENTION

The present invention related to a utility extension cord or hose, which reduces the potential for tripping a pedestrian when a pedestrian walks over it. The shape of the cord, the color of the cord, the markings on the cord and the means to secure the cord or hose to the floor or walk surface assist in making the cord or hose safer to walk over or roll articles over.

The above mentioned objectives are accomplished by the present invention by constructing a utility cord with sloped sides and/or edges which will make the cord function as a ramp or incline when approached from either side. Velcro tape, suction cups, barbs, or adhesives may be added to the cord surface which is laid against the floor to assist in securing the utility cord to the floor for the purpose of further reducing the potential to trip a person who walks over the cord. The utility cord may be used for, but not limited to, electrical extension cords, telephone cords, computer cords, fiber optic cords, water hoses, refrigeration hoses, hydraulic hoses, or steam lines.

Color, embossing, or engraving may be added to the extension cords or hoses to improve visibility or intensify characteristics of the extension cord such as utility type, capacity, length, strength, or size.

### BRIEF DESCRIPTION OF THE DRAWINGS

FIG. 1 is a view of the top side and end of a utility cord showing the sloped sides 6, the raised ribs 4, which will secure into the grooved trough 5 when the cord is rolled up. A communication cable 11 is shown in the cross section of the cord end along with the slots 7, which house Velcro barbs 8, which assist in securing the bottom surface 16 of the utility cord 19 to a carpet floor.

FIG. 2 is an end view of a utility cord 19, which shows the utility as being an insulated 2 electrical power cord having electrical wires 1, extending the length of the cord. The housing 3 of the utility cord is also trip resistant to pedestrians walking over the cord because of its sloped sides 6 and it being secured to the floor by barbs 8.

FIG. 3 is similar to FIG. 2 except that in this case the utilities are a communication cable 11 and a telephone cable 12 and a fiber optic cable 13. A series of suction cups 9 secure the utility cable to the floor 20.

FIG. 4 is similar to FIG. 2 except that one more example of many-sloped side 6 is shown. In this case, the utility cord 19 is in the shape of a triangle and the utility is a refrigerant tube 14.

FIG. 5 is similar to FIG. 4 except that the utility is a water hose 15.

FIG. 6 is similar to FIG. 1 except that the bottom side 16 of the utility cord and cross section end view are shown. This bottom view further illustrates the use of a grooved trough 5 and multiple suction cups 9 made into the bottom of the flexible utility cord housing 3.

FIG. 7 shows the cross section of a rolled up 10 utility cord and how the raised ridges 4 can fit into the grooved troughs 5 in order to stabilize and secure the utility cord when it is rolled up.

FIG. 8 shows the top view of a utility cord 19 with a quick connect female plug 18 or coupler on one end of the utility cord and a male plug 19 or connector is shown on the other end.

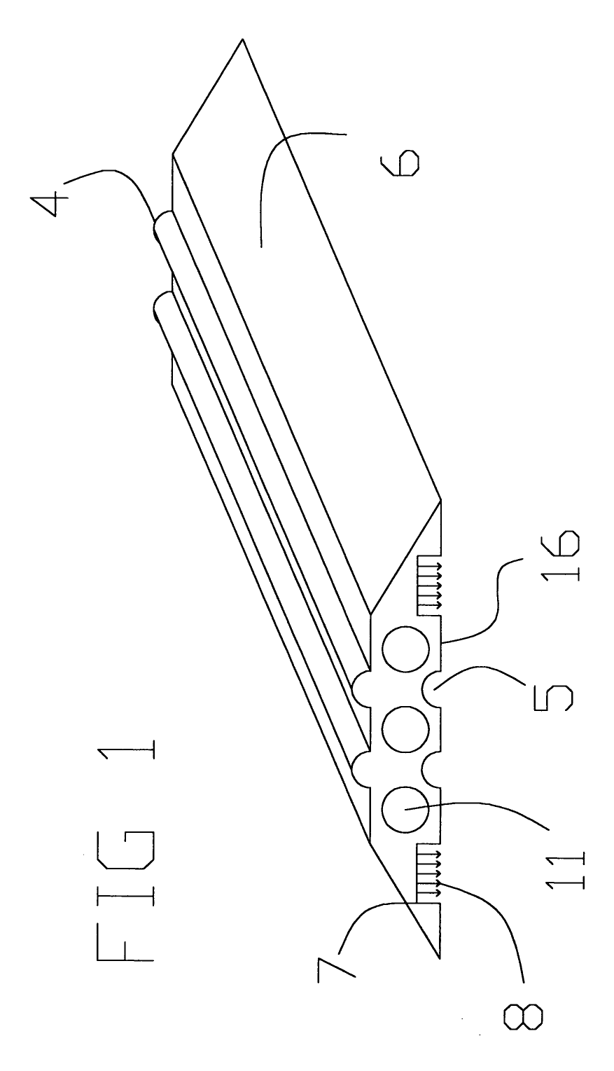

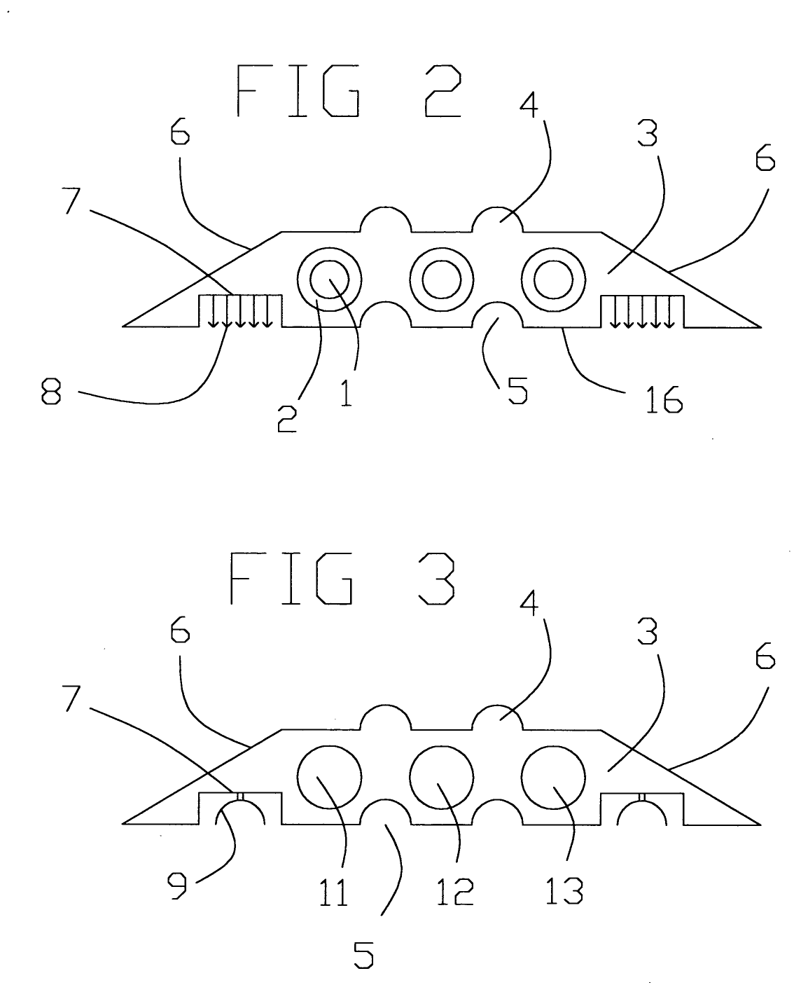

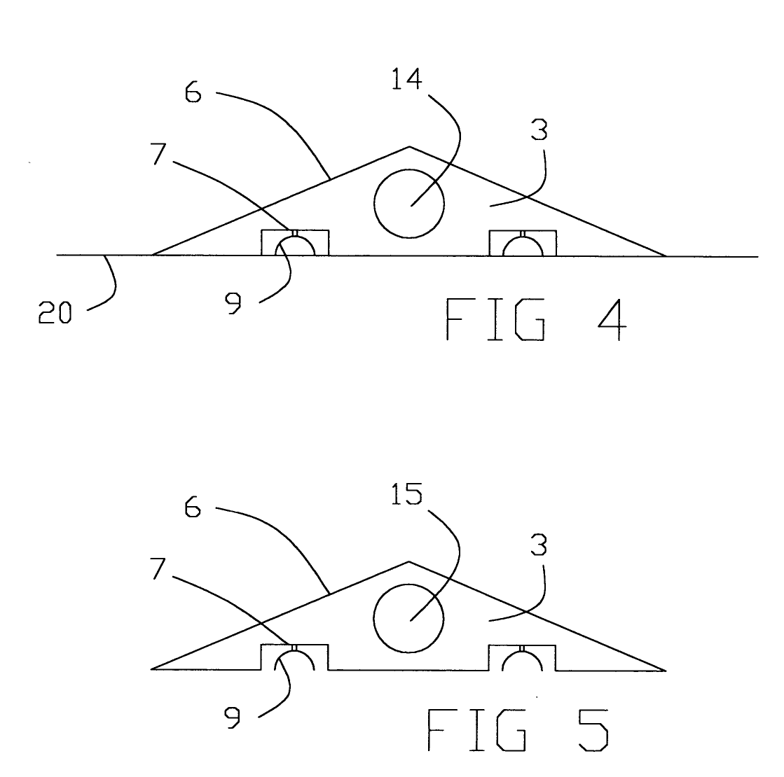

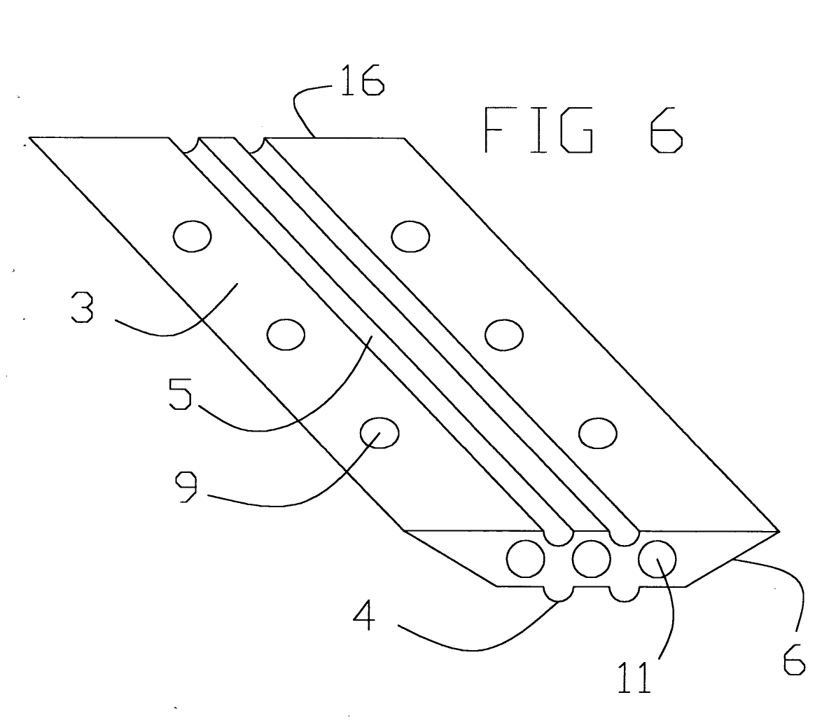

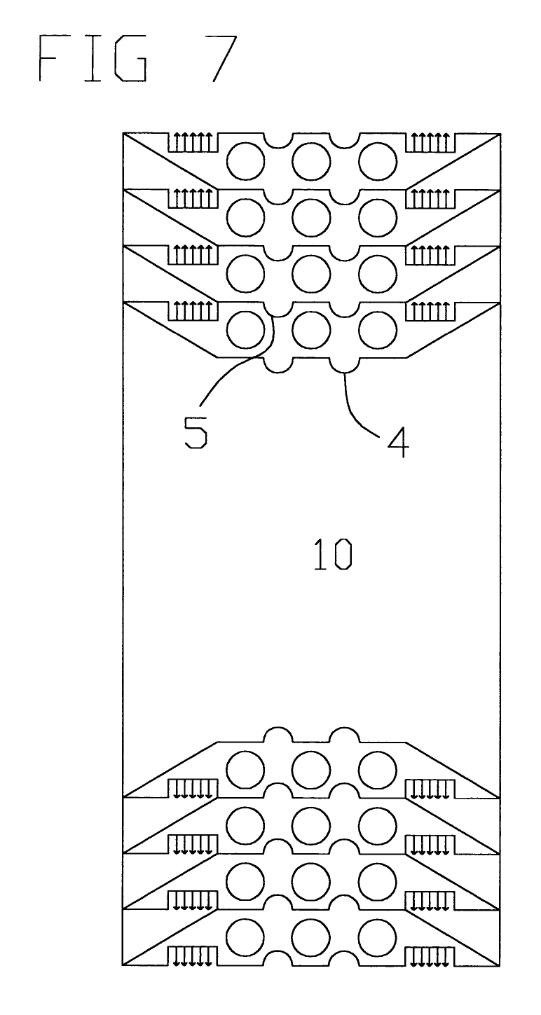

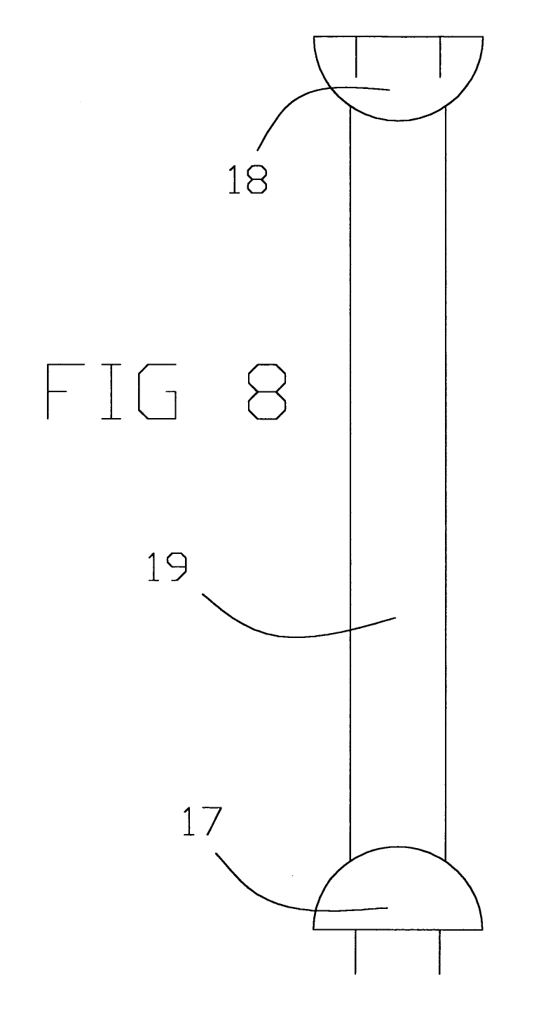

### DESCRIPTION OF THE PREFERRED EMBODIMENT

It is the objective of this invention to provide a flexible utility extension cord 19 having a male utility connector 17 or a female utility connector 18 for a variety of utilities such as an electrical power wire 1 with an insulated cover 2, a communication cable 11, a telephone cable 12, a fiber optic cable 13, a refrigerant tube 14 or a water hose 15.

The objective of this invention is to provide a utility extension cord 19, which is resistant to tripping a pedestrian who walks over it, is accomplished by a utility extension cord 19 consisting of a flexible housing 3, which has its sides 6 shaped as a sloped edge or incline and may include means to secure the bottom side 16 of the utility cord 19 to a floor surface 20, suction cups 9, or barbs 8 such as Velcro tape or adhesive may be used as the means to secure the bottom side 16 of the utility cord to a floor surface. A utility cord that is secured and has sloping sides is less likely to trip a pedestrian walking over it than a conventional thick-sided utility cord, which may also curl up or stand above the floor.

Another objective of the present invention is to provide a means to neatly roll 10 up the utility cord using raised ribs 4, which will secure into grooves 5 when rolled up.

| # | DEFINITIONS |
|---|---|
| 1 | Electrical wire |
| 2 | Electrical insulation |
| 3 | Flexible utility cord housing |
| 4 | Ridged rib |
| 5 | Grooved trough |
| 6 | Sloped edge-non trip edge |
| 7 | Slot to house attachment means |
| 8 | Velcro type barb example of means to attach cord to a carpet or |
| | cloth floor or surface |
| 9 | Suction cup example of means to attach extension cord to a smooth |
| | floor or surface |
| 10 | Rolled up electrical cord showing the interlocking of the Ridge rib |
| | 4 into the grooved trough 5 |
| 11 | Communication cable |
| 12 | Telephone cable |
| 13 | Fiber optic cable |
| 14 | Refrigerant tube |
| 15 | Water hose |
| 16 | Bottom side of utility cord |
| 17 | Male utility cord connector |
| 18 | Female utility cord connector |
| 19 | Utility cord |
| 20 | Floor |

1. A utility extension cord means consisting of an external housing configuration so as to have two sides of the cord ramped or sloped.

2. The means in claim 1 wherein the utility extension cord or hose is chosen from an electrical power cord, a communication cord, a computer wire cord, a telephone cord, a fiber optic cord, a water hose, a heater hose, or a refrigerant hose.

3. The means in CLAIM 2 wherein a means to secure the cord or hose to the floor is a part of the cord or hose.

4. The means in CLAIM 2 wherein a means to secure the cord or hose to the floor is chosen from an adhesive, a pliable material having adhesive properties, suction cups, Velcro, mechanical latches, spined impingements, to attach to carpet or fabric or vacuum means.

5. The means in CLAIM 2 wherein a male and female ribbed and grooved means provided a locking or stabilizing means of the cord securing itself to itself when rolled up claim 6. The means in CLAIM 2 wherein a labeling means chosen from color coding, embossing, or engraving may be used to identify utility type, size, quantity, floor attachment means or length of cord or hose.
